(19) United States
(12) Patent Application Publication
(10) Pub. No.: US 2010/0024493 A1
(43) Pub. Date: Feb. 4, 2010

(54) MULTIPLE LAUNDRY TREATING MACHINE

(76) Inventors: Seong Hae Jeong, Changwon-Si (KR); Seong Jin Jo, Changwon-Si (KR)

Correspondence Address: BIRCH STEWART KOLASCH & BIRCH, PO BOX 747, FALLS CHURCH, VA, 22040-0747, US

(21) Appl. No.: 12/517,702

(22) PCT Filed: Dec. 20, 2007
(86) PCT No.: PCT/KR07/06682

§ 371 Date: Jun. 4, 2009

(30) Foreign Application Priority Data
Jan. 10, 2007 (KR) 10-2007-002802

(51) Int. Cl. B08B 3/12

(52) U.S. Cl. 68/3 SS

(57) ABSTRACT

The present invention relates to complex laundry treating machines. More specifically, the present invention relates to a complex laundry treating machine having a washing machine of a new concept which serves as a pedestal for supporting a washing machine or dryer as well as a washing machine. The complex laundry treating machine includes a main laundry treating machine for washing or drying laundry, a supplementary laundry treating machine having a washing tub mounted therein, and a volume and a height smaller than the volume and the height of the main laundry treating machine for supporting the main laundry treating machine, and ultrasonic washing means for making washing water in the washing tub to vibrate to wash the laundry, thereby permitting to treat a small amount of laundry with the supplementary laundry treating machine without putting a relatively large sized washing machine into operation, to save energy and for convenience of use.

### TECHNICAL FIELD

The present invention relates to complex laundry treating machines. More specifically, the present invention relates to a complex laundry treating machine in which a supplementary laundry treating machine is combined to a general laundry treating machine, to provide a complex laundry treating machine convenient to use.

### BACKGROUND ART

In general, the laundry treating machine is a machine which can wash, dry, or wash and dry the laundry. The laundry treating machine can perform a washing or drying function or both the washing and drying functions. Recently, laundry treating machines each having a steam generator are come into wide use, which has a refresh function such as removal of creases, deodoring, removal of static electricity from the laundry.

In the meantime, according to directions of laundry introduction/taking out, in related art laundry machines, there are front loading type laundry machines and top loading type laundry machines. According to washing systems, there are upright type laundry treating machines in each of which a pulsator or a washing tub rotates, and a horizontal type laundry treating machines in each of which a drum rotates. Typical examples of the horizontal type laundry treating machines are the drum type washing machines or dryers.

Currently, it is a trend that the laundry treating machines become larger gradually, keeping pace with demands of users. That is, sizes of domestic laundry treating machines also become larger, gradually.

In general, every home has a large sized washing machine. Therefore, if it is intended to sort the laundry by laundry kinds, and wash different kinds of laundry separately, it is required to run the washing machine many times. For an example, if it is intended to sort the laundry into clothes of grown-ups, and underwear and baby clothes, and wash clothes of grown-ups, and underwear and baby clothes, separately, it is required to run the washing machine again for washing the latter after finishing washing of the former. Due to this, much washing time period is required, and much energy is consumed.

Moreover, it is not desirable to use the large sized washing machine the same as in the related art for washing a small amount of laundry in view of energy saving. Because a washing course of the large sized washing machine anticipates a case the amount of the laundry is large, water consumption is large, and because a large sized drum is to rotate, power consumption is large. Moreover, because the washing course anticipates the large amount of laundry, a washing time period is long, comparatively.

Moreover, since the large sized washing machine has the washing courses provided anticipating general clothes, the large sized washing machine is not favorable for washing clothes of fine fabrics, such as underwear or baby clothes.

The large sized washing machine is not favorable for frequent washing of small amounts of clothes. The users collect laundry for days or more for washing the laundry at a time.

Leaving the underwear and the baby clothes is not favorable in view of cleanness. The long time leaving of such laundry, letting dirt to stick thereto, also causes a problem of failure of making clean washing.

Therefore, a small sized washing machine is required, which is substantially smaller than the related art large sized washing machine. However, even if it is small, side by side installation of two washing machines in one home is not desirable in view of utilization of a space and good looking.

FIG. 1 illustrates a perspective view of a related art laundry treating machine.

Referring to FIG. 1, the related art laundry treating machine is provided with a body 10 which forms an exterior of the related art laundry treating machine, and a control panel (not shown) on a front or top of the body.

The laundry treating machine may be a washing machine, a dryer, or a washing machine having a drying function.

In the meantime, the related art laundry treating machine may be provided with a pedestal 20 for supporting the body 10 on a floor. The body 10 is installed on the pedestal 20.

However, the pedestal 20 has been used only for supporting the related art washing machine or dryer, but has failed to use the pedestal 20 other than that.

### DISCLOSURE OF INVENTION

### Technical Problem

To solve the problems, an object of the present invention is to provide a supplementary laundry treating machine which enables washing of small amount of laundry, without operating a large laundry machine, and can serve as a pedestal of a dryer or a washing machine.

Another object of the present invention is to provide a complex laundry treating machine which can be realized by using the related art laundry treating machine and a pedestal thereof.

Another object of the present invention is to provide a supplementary laundry treating machine having ultrasonic washing means which performs, not only cloths washing, but also sterilization of clothes by means of a supplementary laundry treating machine provided separate from a large sized washing machine.

### Technical Solution

To achieve these objects and other advantages and in accordance with the purpose of the invention, as embodied and broadly described herein, a supplementary laundry treating machine includes a case having a volume and a height smaller than the volume and the height of a main laundry treating machine for making stable supporting of the main laundry treating machine, a washing tub in the case for holding the laundry, and ultrasonic washing means for making washing water in the washing tub to vibrate to wash the laundry.

The case may be a pedestal for supporting the main laundry treating machine on a floor. The case of the supplementary laundry treating machine may have a drawer in a front of the supplementary laundry treating machine for drawing forward. In this case, a laundry holding space in the supplementary laundry treating machine is an inside space of the drawer.

The main laundry treating machine may be a general dryer, or a washing machine having a drying function. However, as described later, such a dryer or a washing machine having a drying function will have means for being in communication with the supplementary laundry treating machine.

The ultrasonic washing means includes a vibration unit for converting an electric energy into a mechanical vibration energy to generate an ultrasonic wave, a booster for enlarging an amplitude of the ultrasonic wave generated at the vibration unit, and a horn coupled to the booster for transmission of the ultrasonic wave enlarged thus at the booster to the water in a water tank.

Preferably, the ultrasonic washing means is located on a bottom of the washing tub.

Accordingly, the user can wash laundry or dry a large amount of laundry with the drum in the main laundry treating machine, and, not only wash dirt from the laundry but also sterilizing microbes on the laundry with the ultrasonic washing means provided in the washing space of the drawer in the supplementary laundry treating machine.

### ADVANTAGEOUS EFFECTS

The complex laundry treating machine of the present invention permits to treat a small amount of laundry with the supplementary laundry treating machine without putting a relatively large sized washing machine into operation, to save energy and for convenience of use.

The supplementary laundry treating machine and the main laundry treating machine on the supplementary laundry treating machine permit to wash different kinds of the laundry separately at the same time by sorting the laundry according to kinds.

The sterilizing washing means in the supplementary laundry treating machine permits to make easy sterilizing washing of the laundry.

### BRIEF DESCRIPTION OF THE DRAWINGS

FIG. 1 illustrates a perspective view of a related art laundry treating machine;

FIG. 2 illustrates a perspective view of a complex laundry treating machine in accordance with a preferred embodiment of the present invention;

FIG. 3 illustrates an exploded perspective view of joining means for joining a supplementary laundry treating machine and a main laundry treating machine on the supplementary laundry treating machine, together;

FIG. 4 illustrates a longitudinal section of a supplementary laundry treating machine in accordance with a preferred embodiment of the present invention;

FIG. 5 illustrates an exploded perspective view of ultrasonic washing means; and

FIG. 6 illustrates a longitudinal section of a complex laundry treating machine in accordance with a preferred embodiment of the present invention.

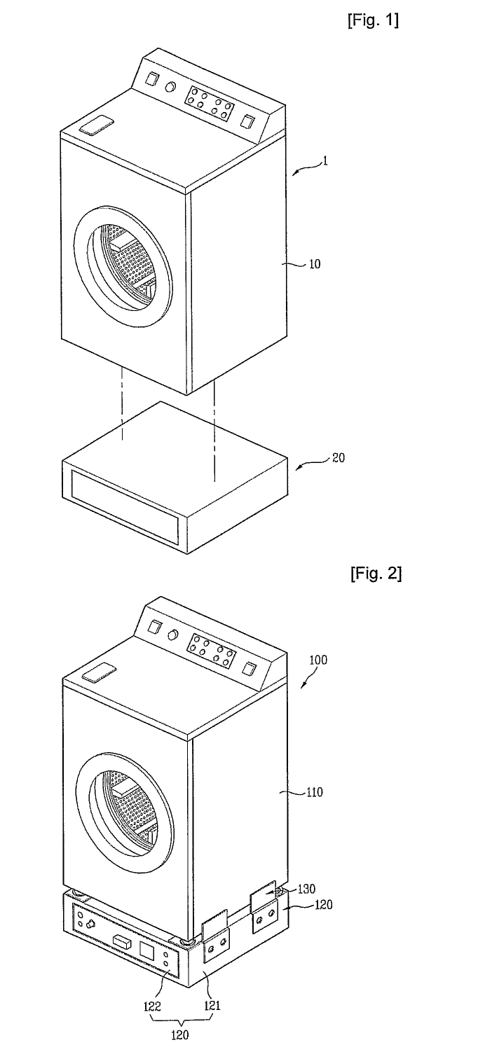

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts. In the meantime, in the present invention, a main laundry treating machine can be the same with a body of a general washing machine. Of course, the main laundry treating machine can have detailed elements which are the same with the general washing machine. Therefore, detailed description of elements of the laundry treating machine of the present invention identical to the related art general washing machine will be omitted.

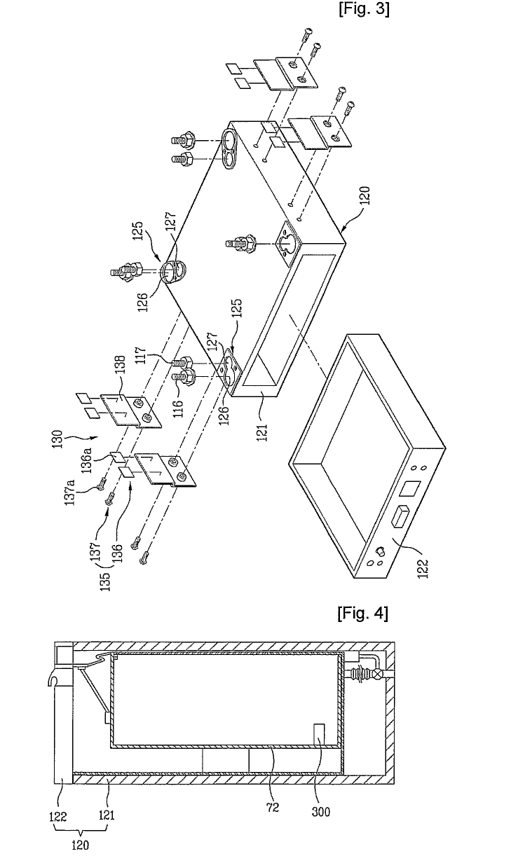

A complex laundry treating machine in accordance with a preferred embodiment of the present invention will be described in detail with reference to FIGS. 2 and 3. FIG. 2 illustrates a perspective view of a complex laundry treating machine in accordance with a preferred embodiment of the present invention, and FIG. 3 illustrates an exploded perspective view of joining means for joining a supplementary laundry treating machine and a main laundry treating machine on the supplementary laundry treating machine, together.

The complex laundry treating machine of the present invention may have an exterior the same with a related art washing machine having a pedestal. However, referring to FIGS. 2 to 3, the complex laundry treating machine of the present invention is different from the related art washing machine I that the pedestal, not only has a function of a pedestal, but also has a function of supplementary laundry treating, to serve as a supplementary laundry treating machine. For stable joining of the main laundry treating machine to the supplementary laundry treating machine, joining means 130 is provided.

Referring to FIG. 2, the supplementary laundry treating machine 120 of the present invention is provided on one side of, and preferably under the main laundry treating machine 110. The supplementary laundry treating machine 120 has a case 121 and a slidably mounted drawer 122. It is preferable that the main laundry treating machine 110 has a washing tub mounted therein for holding and washing the laundry, and a drum mounted in the washing tub.

In the present invention, it is preferable that a volume of the supplementary laundry treating machine 120 is smaller than a volume of the main laundry treating machine 110 the supplementary laundry treating machine 120 is joined thereto. It is preferable that supplementary laundry treating machine 120 has a height lower than the main laundry treating machine 110, because the object of the present invention to provide the supplementary laundry treating machine 120 for supplementing functions of the main laundry treating machine 110 installed thereon.

In view of stability or an exterior design of the complex laundry treating machine 100, because the supplementary laundry treating machine 120 serves as a pedestal of the main laundry treating machine 110, at least one of width, or length of the supplementary laundry treating machine 120 is the same with or longer than a width or length of the main laundry treating machine 110.

In the meantime, the complex laundry treating machine 100 of the present invention includes joining means 130 for joining the main laundry treating machine 110 and the supplementary laundry treating machine 120, together. The supplementary laundry treating machine 120 supports the main laundry treating machine 110 on a floor.

The joining means 130 for joining the supplementary laundry treating machine 120 and the main laundry treating machine 110 together will be described with reference to FIG. 3.

Referring to FIG. 3, the joining means 130 may include leg supporters 125 on a top of the supplementary laundry treating machine 120 for supporting sides of bottom legs 116 and 117 of the main laundry treating machine 110.

Each of the leg supporters 125 includes a panel having a first seating hole 126 for seating a leg 116 a washing machine having a drying function, and a second seating hole 127 for seating a dryer leg 117, and is fastened to the top of the supplementary laundry treating machine 120 with screws. The washing machine having a drying function and the dryer are modes of the laundry treating machine, wherein a mode is taken as an example, in which an exterior of the washing machine having a drying function is greater than an exterior of the dryer.

The leg supporters 125 are fixedly secured to comers of the top of the supplementary laundry treating machine 120 respectively, wherein the first seating hole 126 and the second seating hole 127 of each of the two leg supporters at front corners of the supplementary laundry treating machine 120 are joined with each other, and the first seating hole 126 and the second seating hole 127 of each of the two leg supporters at rear corners of the supplementary laundry treating machine 120 are not joined with each other, for easy seating of the leg 116 of the main laundry machine legs 110.

The first seating hole 126 is located on an outer side of the second seating hole 127 with respect to a diagonal line of the underside of the main laundry treating machine 110. This is because, in general, the body of the washing machine is greater than the body of the laundry dryer.

The joining means 130 includes a joining member 138 provided to sides of the supplementary laundry treating machine 120, and fastening members 135 for fastening the joining member to the sides of the main laundry treating machine 110 and the supplementary laundry treating machine 120.

Referring to FIG. 3, the joining member may include two or more than two joining members 138 each for securing abutted sides of the hexahedral supplementary laundry treating machine 120, and the hexahedral main laundry treating machine 110, to each other.

In addition to this, the joining member 138 may also include a third fastening member (not shown) for securing abutted rear sides of the supplementary laundry treating machine 120, and the main laundry treating machine 110, to each other.

In this instance, the joining means 130 may be designed to cope with height variations of the washing machine legs 116 or the laundry dryer legs 117.

The fastening member 135 includes a first fastening member 136 for securing an upper portion of the joining member 138 to a lower portion of a side of the main laundry treating machine 110, and a second fastening member 137 for securing a lower portion of the joining member 138 to an upper portion of a side of the supplementary laundry treating machine 120.

In this instance, at least one of the first fastening member 136 and the second fastening member 137 may be one having adhesive applied to both sides, for an example, a two sided tape.

Different from above, at least one of the first fastening member 136 and the second fastening member 137 may be fastening means, such as screws. If the fastening member is the screws, preferably, the upper portion of the joining member 138 has fastening holes formed at fixed intervals.

In the meantime, different from above, the means for joining the main laundry treating machine 110 to the supplementary laundry treating machine 120 can be modified in a variety of forms.

FIG. 4 illustrates a longitudinal section of a supplementary laundry treating machine in accordance with a preferred embodiment of the present invention.

Referring to FIG. 4, the supplementary laundry treating machine 120 includes a case 121 and a slidable drawer 122 having a washing tub 72 therein for washing laundry or the like.

Mounted under the washing tub 72, there is ultrasonic washing means 300. The ultrasonic wave is generated as air or a substance vibrates. If the substance vibrates, air surrounding the substance vibrates, to make a drum membrane to vibrate letting a person to hear a sound. The sound wave propagates in an elastic substance as material particles of the substance compressed and expanded. Because atoms of gas, liquid, and solid have elasticity to one another, the sound wave can exist, in principle. In this instance, the ultrasonic wave is sound wave having too high frequency to hear, i.e., a sound wave exceeding an audible frequency range (20 Hz˜20 KHz) of the sound wave.

If the ultrasonic wave is generated in water having an object placed therein, foreign matters can be removed completely, not only from a surface of the object, but also from chinks in the object, and, at the same time with this, sterilization is possible.

The ultrasonic wave can wash dirt because the ultrasonic wave itself causes vibration in which strength and weakness is repeated for tens of thousand times, to repeat pushing and pulling of water molecules at the surface of water. Then, bonding force between the water molecules is broken to form tens of thousand minute cavities which absorb dirt from the surface of the laundry like a vacuum cleaner.

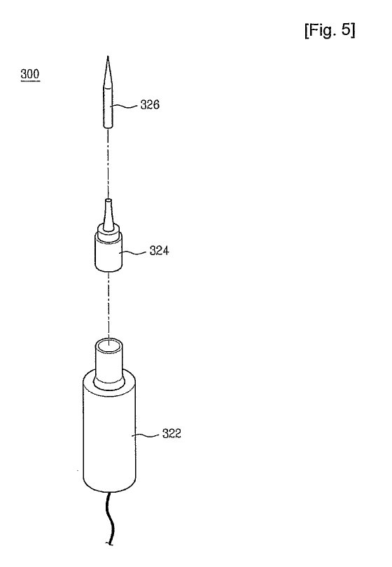

FIG. 5 illustrates an exploded perspective view of ultrasonic washing means.

Referring to FIG. 5, the ultrasonic washing means 300 includes a vibration unit 322 for converting an electric energy into a mechanical vibration energy to generate an ultrasonic wave, a booster 324 coupled to the vibration unit 322 for enlarging an amplitude of the ultrasonic wave generated at the vibration unit 322, and a horn 326 coupled to the booster 324 for transmission of the ultrasonic wave enlarged thus at the booster 324 to the water in a water tank.

The operation of the ultrasonic washing means will be described.

Upon application of an electric signal to the vibration unit 322, piezoelectric ceramic (not shown) in the vibration unit 322 contacts/expands repeatedly, to form vibration.

In this instance, since the vibration of the piezoelectric ceramic (not shown) has not so large amplitude, the booster 324 coupled to the vibration unit 322 receives the vibration from the piezoelectric ceramic (not shown), and enlarge the amplitude.

The enlarged vibration is transmitted to the water in the washing tub 72 by the horn 326.

If the vibration is transmitted to the water in the washing tub 72, cavitational bubbles are generated in the water, having a high temperature and a high pressure formed therein. A high temperature and high pressure shock wave generated at the time the bubbles break kill microbes in the water.

The high pressure and high temperature takes place for a short time period of a few hundredths to a few thousandths of one second. Such a powerful force scatters and decomposes the dirt to have a washing effect.

That is, by making the cavitational bubbles to hit the surface of the laundry, generating a high speed shock wave, foreign matters are made to fall off the laundry to have the washing effect.

According to this, the ultrasonic washing means 300 can wash off the dirt and sterilize the microbes on the laundry.

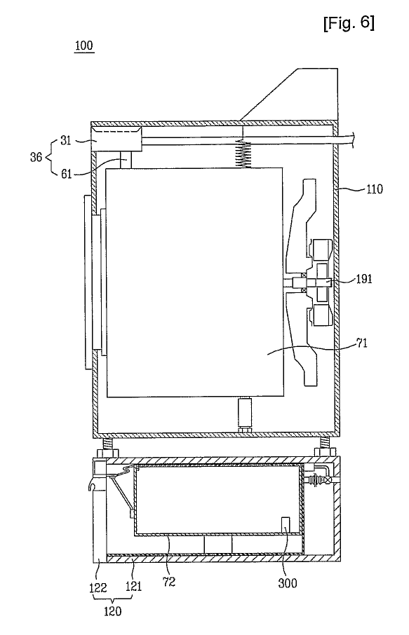

FIG. 6 illustrates a longitudinal section of a complex laundry treating machine in accordance with a preferred embodiment of the present invention.

Referring to FIG. 6, the complex laundry treating machine 100 includes a main laundry treating machine 110 and a supplementary laundry treating machine 120.

The main laundry treating machine 110 can wash or dry laundry. As described before, the supplementary laundry treating machine 120 supports the main laundry treating machine 110, has a volume and a height smaller than a volume and a height of the main laundry treating machine 110 respectively, and includes a washing tub 72 provided therein.

The washing tub 72 has a ultrasonic washing means 300 mounted on a bottom.

The supplementary laundry treating machine 120 supports the washing tub 72 and has a drawer 122 drawable to forward.

In the meantime, the complex laundry treating machine 100 of the present invention includes a main washing tub 71 mounted in the main laundry treating machine 110 for enabling washing with the main laundry treating machine 110, and a main motor unit 191 for transmission of rotating power to the main washing tub 71.

In this instance, it is preferable that the main washing tub 71 is of a drum type, provided with an inner tub (not shown) for holding the laundry, and an outer tub (not shown) on an outside of the inner tub for flow in/out of washing water from/to the inner tub.

In order to make an effective washing of the laundry with the main washing tub 71, detergent may be introduced to the main washing tub 71. According to this, the main laundry treating machine 110 may include a detergent supply unit 36 having a detergent box 31 and a main connection flow passage 61 for connecting the detergent box 31 and the main washing tub 71.

According to this, if it is intended to wash laundry with the complex laundry treating machine 100, the laundry with a large volume or amount can be washed with the main laundry treating machine 110.

The laundry with a small volume or which requires sterilizing washing without detergent may be washed with the supplementary laundry treating machine 120.

### INDUSTRIAL APPLICABILITY

The complex laundry treating machine of the present invention permits to treat a small amount of laundry with the supplementary laundry treating machine without putting a relatively large sized washing machine into operation, to save energy and for convenience of use.

The supplementary laundry treating machine and the main laundry treating machine on the supplementary laundry treating machine permit to wash different kinds of the laundry separately at the same time by sorting the laundry according to kinds.

The sterilizing washing means in the supplementary laundry treating machine permits to make easy sterilizing washing of the laundry.

1. A supplementary laundry treating machine comprising:
a case having a volume and a height smaller than a volume and a height of a main laundry treating machine for making stable supporting of the main laundry treating machine;
a washing tub in the case holding the laundry; and
ultrasonic washing means making washing water in the washing tub to vibrate to wash the laundry.

2. The supplementary laundry treating machine as claimed in claim 1, wherein the ultrasonic washing means includes;
a vibration unit converting an electric energy into a mechanical vibration energy to generate an ultrasonic wave,
a booster enlarging an amplitude of the ultrasonic wave generated at the vibration unit, and
a horn coupled to the booster for transmission of the ultrasonic wave enlarged thus at the booster to the water in a water tank.

3. The supplementary laundry treating machine as claimed in claim 1, wherein the ultrasonic washing means is located on a bottom of the washing tub.

4. A complex laundry treating machine comprising:
a main laundry treating machine washing or drying laundry;
a supplementary laundry treating machine having a washing tub mounted therein, and a volume and a height smaller than a volume and a height of the main laundry treating machine supporting the main laundry treating machine; and
ultrasonic washing means making washing water in the washing tub to vibrate to wash the laundry.

5. The complex laundry treating machine as claimed in claim 4, wherein the ultrasonic washing means includes;
a vibration unit converting an electric energy into a mechanical vibration energy to generate an ultrasonic wave,
a booster enlarging an amplitude of the ultrasonic wave generated at the vibration unit, and
a horn coupled to the booster for transmission of the ultrasonic wave enlarged thus at the booster to the water in a water tank.

6. The complex laundry treating machine as claimed in claim 4, wherein the ultrasonic washing means is located on a bottom of the washing tub.

7. The complex laundry treating machine as claimed in claim 4, wherein the main laundry treating machine includes a main washing tub.

8. The complex laundry treating machine as claimed in claim 4, wherein the supplementary laundry treating machine includes a drawer supporting the washing tub, the drawer being moveable forwardly.

9. The complex laundry treating machine as claimed in claim 4, further comprising a joining means fastening the supplementary laundry treating machine to one side of the main laundry treating machine.

10. The complex laundry treating machine as claimed in claim 9, wherein the joining means includes;
a joining member provided to sides of the supplementary laundry treating machine, and
fastening members fastening the joining member to the sides of the main laundry treating machine and the supplementary laundry treating machine.

11. The complex laundry treating machine as claimed in claim 10, wherein there are a plurality of the joining members.

12. The complex laundry treating machine as claimed in claim 10, wherein the fastening member includes;
a first fastening member securing an upper portion of the joining member to a lower portion of a side of the main laundry treating machine, and
a second fastening member securing a lower portion of the joining member to an upper portion of a side of the supplementary laundry treating machine.
